(19) United States
(12) Patent Application Publication
(10) Pub. No.: US 2007/0168551 A1
(43) Pub. Date: Jul. 19, 2007

(54) Address and port number abstraction when setting up a connection between at least two computational devices

(75) Inventor: Jurjen Henri Eisink, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/598,227

(22) PCT Filed: Feb. 28, 2005
(86) PCT No.: PCT/IB05/50717

§ 371 Date: Aug. 22, 2006

(30) Foreign Application Priority Data
Mar. 2, 2004 (EP) 04100823.6

(51) Int. Cl. G06F 15/16

(52) U.S. Cl. 709/245

(57) ABSTRACT

The invention relates to a method, computational devices, a system of computational devices and computer program products for abstracting address and port number usage for an application running on first and second devices. The system comprises a first device (10) that receives a request for binding of a socket to a service from the application in said first device, obtains a service name, generates a resource record (26) comprising a binding between a port number and the service name, creates a socket and binds it to the port number, and sends the record to a resolving unit (22) associated with the first device, and a second device (16) that receives a request for a connection from the application in said second device, sends a query regarding the service name to the resolving unit, and receives an address and port number associated with the first device as response to the query.

The present invention generally relates to the field of communication between computational devices and more particularly to the abstraction of address and port number usage when setting up connections between two computational devices. The present invention furthermore relates to a method, computational devices, a system of computational devices and computer program products for such abstraction.

In the field of computer communication there is normally a shortage of available public addresses to be used by different devices. This has led to many local systems having only one or a few public addresses used for the whole local system and then the local system will communicate with a global network via a gateway controlling these few addresses. Normally such a gateway will in this case be using a local addressing system for communicating with the devices in the local network.

In order to initiate sessions from such devices within a local network with other devices via a global network, the gateway can be provided with a NAPT (Network Address and Port Translator) unit, which translates the local address to a global address for the communication with the other devices as well as translates a port number associated with the local address to a port number associated with the global address. A device within the local network can then start a session with a device outside the local network using only one address. This unit can then also be combined with a so-called DNS_ALG (Domain Name System_Application Level Gateway), which replaces the address and port number of the local network with the address and port number of the global network in the payload of responses to queries regarding device and service name and vice versa. The DNS_ALG is however protocol/application specific and in order to enable address and port number translation for different protocols/applications different ALGs have to be implemented. Furthermore restrictions apply to the protocols that can be processed by an ALG with regard to scrambling, use of well-known port numbers etc.

Another device that exists is a so-called DNS (Domain Name System) SRV (Service), which is described by the Internet Society in RFC2782, “DNS SRV RR”, by A. Gulbrandsen, P. Vixie and L. Esibov, February 2000. A DNS SRV receives queries regarding a name of a device and a service and returns an address and a port number as a result of the query. With this DNS SRV device it can be possible to obtain address and port number of a device to be contacted for starting of a session.

Yet another device that exists is an RSIP (Realm-Specific Internet Protocol) device. This device uses another way of providing address translation. The RSIP explicitly requests a mapping of every port opened by a host within a local network. When a port is opened for inbound or outbound communication a mapping is directly created between the local port/address and the global port/address. Due to the fact that the operating system of the host within the local network knows the mapping, it is capable of providing the correct address/port information that has to be included within the payload based on the connection, meaning that addressing information within the local network is included for local communication and addressing information within the global network is included for outside communication, i.e. outside the local network. In this manner no ALGs are needed when using RSIP.

However when using RSIP, address information is only valid within a certain scope. For instance the address information contained within the payload of local communication is only valid within the private network. When a distributed application is used in which at least two parts resides in the local network and at least one other part resides in another network, a problem arises if addressing information of a part of the local network is passed by another part in the local network to a part within the global network. In this case the addressing information has to be translated.

There is thus a need for resolving the address translation problem associated with application specific communication between devices.

An application thus needs to set up a connection between at least two devices. In this setting up of the connection there is a need for allowing this setup to be performed without having to take account of address translation problems that might arise because of different addressing realms provided by different networks.

It is therefore an object of the present invention to provide a mechanism by which a connection can be set up between at least two computational devices provided in different networks that works independently of if the devices are provided in different addressing realms or not.

According to a first aspect of the present invention, this object is obtained by a method of abstracting address and port number usage for an application running on at least a first and a second device and comprising, in the first device, the steps of:

receiving a request for binding of a socket to a service from the application in said first device,

obtaining an application specific service name to be used for a connection between the devices,

generating a resource record comprising a binding between at least a port number of said first device on the one hand and the application specific service name on the other hand,

creating a socket and binding it to the port number, and

ordering the sending of the resource record to an associated local name and service resolving unit, such that the resource record can be stored in the name and service resolving unit in order to allow the application running in the second device to obtain an address and port number associated with the first device for use for a connection through sending a query to the name and service resolving unit about the application specific service name of the first device.

According to a second aspect of the present invention, this object is also achieved by first computational device for abstracting address and port number usage for an application running on at least the first and a second device and comprising:

a socket layer engine arranged to:
receive a request for binding of a socket to a service from the application in said first device,
obtain an application specific service name to be used for a connection between the devices,
generate a resource record comprising a binding between at least an own port number on the one hand and the application specific service name on the other hand,
create a socket and bind it to the port number, and
order the sending of the resource record to a local name and service resolving unit associated with the first device, such that the resource record can be stored in the name and service resolving unit, for allowing the application in the second device to obtain an address and port number associated with the first device for use in communication by means of a query regarding at least the application specific service name of the first device.

According to a third aspect of the present invention, the object is also achieved by a second computational device for abstracting address and port number usage for an application running on at least a first and the second device and comprising:

a socket layer engine arranged to:
receive a request for a connection from an application in said second device,
order the sending of a query regarding at least an application specific service name associated with the first device to a name and service resolving unit associated with the first device, which name and service resolving unit has a resource record comprising a binding between an address and a port number of said first device on the one hand and at least the application specific service name on the other hand, and
receive an address and port number associated with the first device as a response to the query for use in setting up a connection, such that the connection can be set up using the received address and port number.

According to a fourth aspect of the present invention, the object is also achieved by a system of computational devices for abstracting address and port number usage for an application running on at least a first and a second device and comprising:

said first computational device having a socket layer engine arranged to:
receive a request for binding of a socket to a service from the application in said first device,
obtain an application specific service name to be used for a connection between the devices,
generate a resource record comprising a binding between at least an own port number on the one hand and the application specific service name on the other hand,
create a socket and bind it to the port number, and
order the sending of the resource record to a local name and service resolving unit associated with the first device, such that the resource record can be stored in the name and service resolving unit,

said second computational device having a socket layer engine arranged to:
receive a request for a connection from an application in said second device,
order the sending of a query regarding the application specific service name associated with the first device to the name and service resolving unit associated with the first device, and
receive an address and port number associated with the first device for use in setting up a connection as a response to the query, such that the connection can be set up using the received address and port number.

According to a fifth aspect of the present invention, the object is also achieved by a computer program product to be used on a first computational device for abstracting address and port number usage for an application running on at least the first and a second device, said computer program product having:

computer program code, to make the first device execute, when said program code is loaded in the first device:
receive a request for binding of a socket to a service from the application in said first device,
obtain an application specific service name to be used for a connection between the devices,
generate a resource record comprising a binding between at least a port number of the first device on the one hand and the application specific service name on the other hand,
create the socket and bind it to the port number, and
order the sending of the resource record to a local name and service resolving unit associated with the first device, such that the resource record can be stored in the name and service resolving unit for allowing the application in the second device to obtain an address and port number associated with the first device for use for setting up a connection by means of a query regarding the device name and application specific service name of the first device.

According to a sixth aspect of the present invention, the object is also achieved by a computer program product to be used on a second computational device for abstracting address and port number usage for an application running on at least a first and the second device, said computer program product having:

computer program code, to make the second device execute, when said program code is loaded in the second device:
receive a request for a connection from an application in said second device,
order the sending of a query regarding at least an application specific service name associated with the first device to a name and service resolving unit associated with the first device, which name and service resolving unit has a resource record comprising a binding between an address and a port number of said first device on the one hand and the application specific service name on the other hand, and
receive an address and port number associated with the first device for use in setting up a connection as a response to the query, such that the connection can be set up using the received address and port number as well as an own address and port number.

According to claims 2 and 12, the resource record also includes a binding between a locatable device name and an address of the first device, which relieves the name and service resolving unit from having to provide completing information in the resource record.

According to claims 3 and 13, the application specific service name is sent to the second device, which enables it to use it, when it has no knowledge about the name.

According to claims 5 and 15, the service name is provided by the application.

According to claims 6 and 16, the service name is generated, which is needed in case the application does not have a name for the service.

According to claim 7 and 17, the generated service name is returned to the application. In this way the application running on the first device can provide the service name to the application running on the second device in order to enable contacting of the first device from the second device.

According to claims 8 and 18, the resource record is removed once it is no longer in use for the connection. This aids the unnecessary binding of port numbers. It is also beneficial in case port numbers and service names are changed.

According to claims 9 and 19, the service name includes protocol information, which enables the application in the second device to know what protocol to use in case it does not have any prior knowledge.

Claim 10 is directed towards setting up a connection from the second device to the first device based on a query regarding a service name.

An embodiment of the present invention has the advantage of abstracting the use of address and port numbers in relation to setting up connections for an application running on at least two devices. Because of this abstraction, the messages sent for setting up the connection need not include addresses and port number information, which can be affected negatively when provided in a payload traversing interfaces between different addressing realms. Such negative influence comprises for instance scrambling and a data integrity detection mechanism. The addresses and port numbers are obtained through service queries, which guarantees that possible address translations are taken care of automatically in networks if they have address translation capabilities. This furthermore makes the invention network independent and allows it to be implemented virtually for any network. Other advantages are that a special ALG is not required; instead the functionality of the existing one that is provided in relation to normal device name and service name resolving and different addressing realms is used. Multi-tier applications are also enabled. Existing infrastructure can be used, which makes the invention straightforward and cost-efficient to implement. The present invention furthermore enables multiple servers of the same type within a private network without configuration.

The general idea behind an embodiment of the invention is thus to create a resource record, in a first device, including a binding between at least a port number and a service name of the device and sending the resource record to a name and service resolving unit. In this way a connection can be set up from a second device by sending a query regarding the service name to the name and service resolving unit.

These and other aspects of the invention will be apparent from and elucidated with reference to the embodiments described hereinafter.

The present invention will now be explained in more detail in relation to the enclosed drawings, where

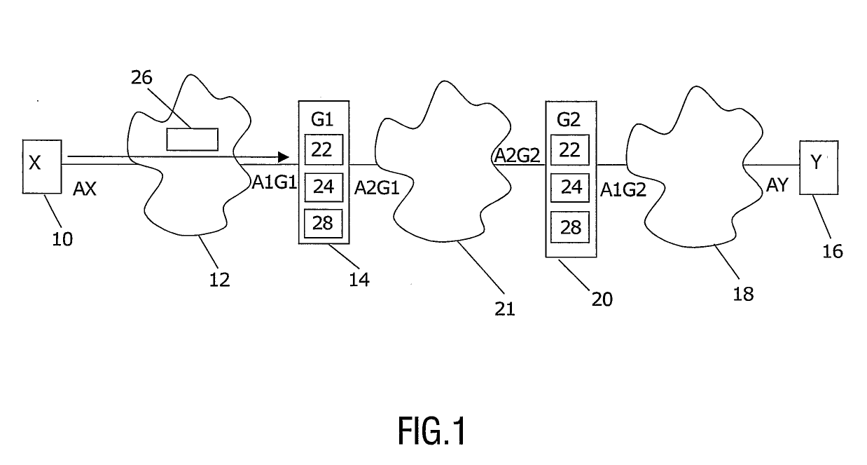

FIG. 1 shows a schematic drawing of a first computational device connected to a global network via a first local network and a second computational device connected to the global network via a second local network,

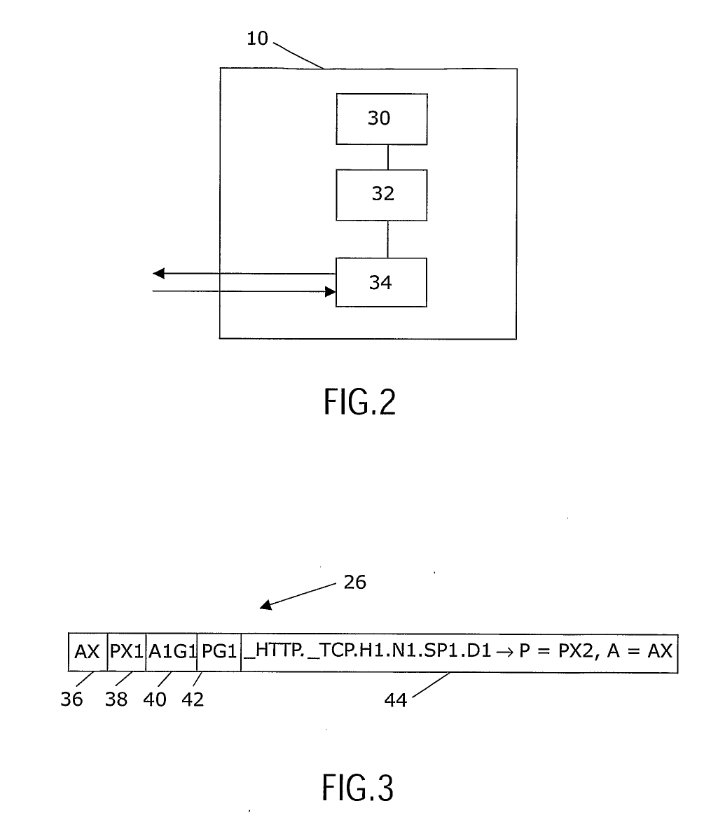

FIG. 2 shows a block schematic of some parts of the first computational device that are relevant for the present invention,

FIG. 3 shows a first type of resource record sent from the first device,

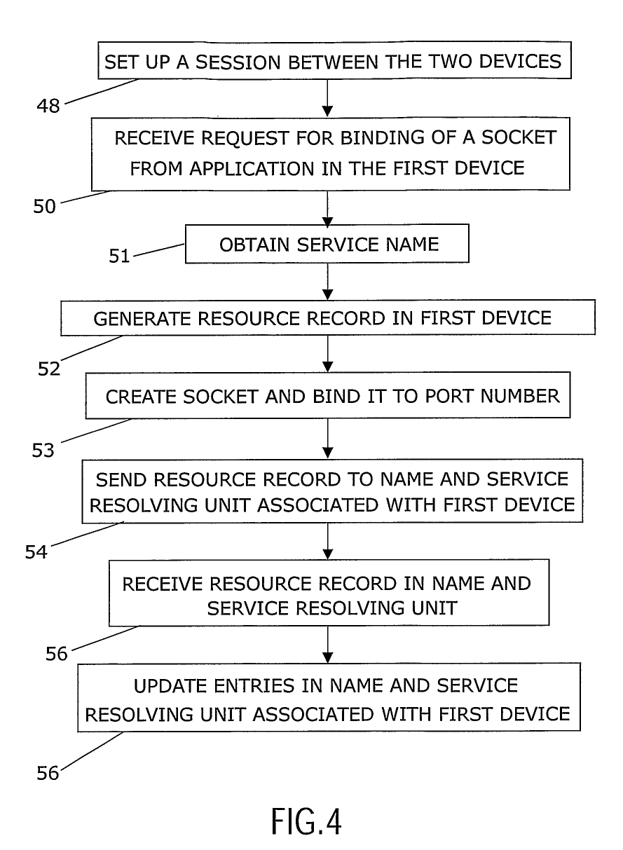

FIG. 4 shows a flow chart of a first part of a method of abstracting address and port number usage for an application run on the two devices by providing a device and service name resolving unit with a resource record,

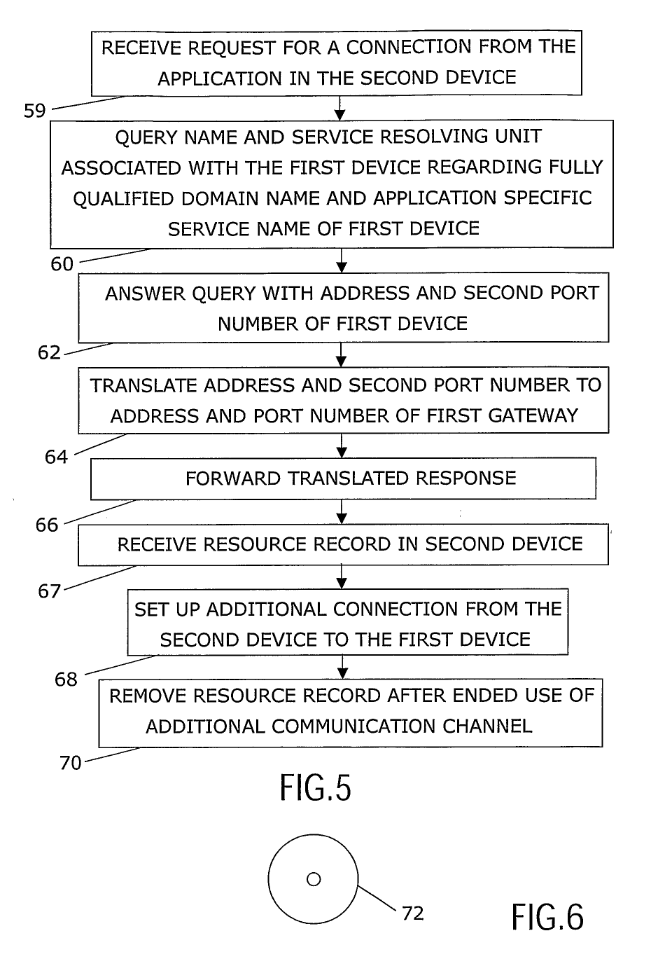

FIG. 5 shows a flow chart of a second part of the method of abstracting address and port number usage for the application run on the two devices by querying the name and service resolving unit about a device name and service name, and

FIG. 6 schematically shows a computer readable medium on which is stored program code for performing the method steps implemented in a computational device according to the invention.

FIG. 1 shows a schematic drawing of an embodiment of the invention and it's environment. FIG. 1 shows a first computational device 10 connected to a first local network 12. The first network 12 has a first gateway 14, which is connected to a global network 21, which in this case is the Internet. A second gateway 20 is provided as an interface between the global network 21 and a second local network 18. The second local network 18 includes a second computational device 16. The first local network 12 has a first addressing realm, the second local network 18 has a second addressing realm and the global network 21 has a third addressing realm. The first addressing realm is here an IP-addressing realm, for instance IPv4 or IPv6, and used locally in the first network, the second addressing realm is also a local addressing realm used inside the second network 18 for instance of the same type as the first addressing realm, while the third addressing realm is a global addressing realm, for instance IPv4. The first and second networks 12 and 18 are in the preferred embodiment private home networks. It should however be realized that the invention is not limited to private home networks, but can also be used for example in corporate networks or even global networks. The first computational device 10 is also denoted X, the second computational device 16 is denoted Y, the first gateway 14 is denoted G1 and the second gateway 20 is denoted G2. The different devices thus have different addresses in the different realms. The first device 10 has an address AX in the first local addressing realm, the first gateway 14 has an address A1G1 in the first local addressing realm and an address A2G1 in the global addressing realm, the second gateway 20 has an address A1G2 in the second local addressing realm and an address A2G2 in the global addressing realm, while the second device 16 has a second address AY in the second local addressing realm. The first and second devices 10 and 16 can be regular computers, but are not limited to this. They can be other computational devices as well such as Internet Radios, printers, scanners or any other type of equipment. It should also be realized that there might be more devices in the local networks. The devices 10 and 16 might for instance be servers or any other suitable devices, which can be connected to the Internet via the gateways. The gateways 14 and 20 each include a name and service resolving unit in the form of a DNS (Domain Name System) SRV (Service) unit 22, an DNS_ALG (Domain Name System_Application Level Gateway) unit 24 and a NAPT (Network Address and Port Translator) table 28. FIG. 1 also shows a first resource record 26 sent from the first device 10 to the first gateway 14. This resource record will be described in more detail shortly.

A simplified version of the first device 10 according to an embodiment of the invention is shown in a block schematic in FIG. 2. It should however be realized that this FIG. 2 is valid also for the second device 16. The first device 10 has an application layer engine 30 arranged to run parts of an application, where another part of the application is running on the second device 16. The application layer engine 30 is connected to a socket layer engine 32, which in turn is connected to a connection layer engine 34. The connection layer engine 34 provides the contact with the first local network for reception and sending of data packets. The application layer engine 30 is run by the application in question, while the socket layer engine 32 and connection layer engine 34 are run by the operating system of the device. The directions the data packets are traveling are indicated with arrows.

FIG. 3 shows a first resource record 26 generated by the first device in some more detail. The resource record has a source address field 36 filled with the address AX of the first device, a source port number field 38 filled with a first port number PX1 of the first device, a destination address field 40, filled with the address A1G1 of the first gateway in first local addressing realm, a destination port number field 42, filled with a dedicated port number PG1 used for resource records and a payload 44, filled with a mapping between a specified service name _HTTP._TCP and device name H1.N1.SP1.D1 on the one hand and an address AX and a second port number PX2 of the first device on the other hand. This resource record 26 is provided for one service named HTTP.

The invention will now be described with reference being made to FIGS. 1, 2, 3, 4 and 5, where FIG. 4 shows a flow chart of a first part of a method of abstracting address and port number usage for an application run on the two devices by providing a device and service name resolving unit with a resource record and FIG. 5 shows a flow chart of a second part of the method of abstracting address and port number usage for an application run on the two devices by querying the name and service resolving unit about a device name and service name.

The method starts with the first device 10 starting a session with the second device 16, step 48. It should here be noted that the session could just as well have been started by the second device 16. The first device 10 starts by sending a device name and service name query in order to get an address for communicating with the second device 16. The query includes a locatable device name and a service name, where the device name is normally the fully qualified domain name of the second device 16. This query is eventually received by the second gateway 20 in the second local network 18 by normal DNS procedures. The second gateway 20 then forwards the query to its name and service resolving unit 22. The name and service resolving unit 22 is a unit with DNS_SRV capabilities, i.e. it maps domain names and service names to addresses and port numbers and here between addresses and port numbers in the global addressing realm and addresses and port numbers in the second local addressing realm. The name and service resolving unit 22 then makes an address and port number look up in the second addressing realm based on the name query and finds an address AY of the second device 16 in the second addressing realm and an associated port number. The name and service resolving unit 22 then generates and returns a response. The response includes the second address AY and the corresponding port number in the payload. The DNS_SRV ALG (Application Level Gateway) unit 24 then replaces the second address AY and said port number with the address A2G2 of the second gateway 20 and another port number associated with the second gateway 20 in the payload of the response. A binding is also made between the address AY and port number of the second device 16 and the address A2G2 and port number of the second gateway 20 in the NAPT table 28 in the second gateway 20. The NAPT 28 is used for translating of local addresses and local port numbers, to global addresses and global port numbers, i.e. from addresses and port numbers in the second local addressing realm into addresses and port number in the global addressing realm and vice versa. The first device 10 then receives the response on the name and service query, which points out the second gateway 20 instead of second device 16 as being associated with the name of device 20 and a port number of the gateway as corresponding to the service. The first device can now start a session using the address A2G2 as destination address and its associated port number as destination port number. Then a first packet in the session is sent to the second gateway 20 from the first device 10 using its own first address AX and an own first port number PX1 as source and above mentioned address A2G2 and corresponding port number as destination. A binding is made between this first address AX and first port number PX1, the global address A2G1 of the first gateway 14, an associated port number of the first gateway and the global address A2G2 and corresponding port number of the second gateway 20 in the NAPT table 28 provided in the first gateway 14. The source address AX and port number PX1 are furthermore translated by the first gateway 14 into the mapped address A2G1 and associated port number and the packet is forwarded by the first gateway 14 to the second gateway 20, which makes an actual binding in its NAPT 28 of the address A2G1 and associated port number to the previously bound address A2G2 and associated port number and address AX with associated port number. The second gateway then translates address A2G2 and associated port number to address AY and associated port number and forwards the packet to the second device 16. More details of this way of initiating a session are described in the applicant's co-pending application entitled INITIATING COMMUNICATION SESSIONS FROM A FIRST COMPUTER NETWORK TO A SECOND COMPUTER NETWORK, European Patent Application Number 04100648.7 (our ref. PHNL040154, filing date 19 Feb. 2004).

In the session now the two applications start running on respective application layer engines 30. The application might now need to set up an extra connection than the one set up for initiating the session. This connection might be needed for different types of applications, for instance if a videoconference session is to be set up. In the present case the second device 16 does this. The application layer engine 30 in the first device 10 then connects to the socket layer engine 32 with a request for binding of a socket to a service, step 50, for enabling a connection from the second device 16. The socket layer engine then obtains a service name to be used for the connection, step 51. The request could include this service name to be used or there might not be one. In this example there is one, named _HTTP. When the socket layer engine 32 has received this request with the associated service name, it goes on and generates a resource record, step 52, which is shown in the payload of the record 26. In this record the application specific service name _HTTP, applicable protocol _TCP as well as a locatable device name in the form of the fully qualified domain name H1.N1.SP1.D1 of the first device 10 is linked to a selected second port number PX2, and the first address AX of the first device in the first local network 12. The socket layer engine 32 then creates the socket and binds it to the port number PX2 and address AX of the first device 10, step 53. The resource record is then provided to the connection layer engine 34, from where it is sent to the first gateway 14 using the address A1G1 of the first gateway G1 and a dedicated port number PG1 associated with the name and service resolving unit 22, step 54. The first gateway 14 then receives the resource record 26, step 56. As the first gateway 14 now has received this resource record 26, it forwards it to its name and service resolving unit 22, which updates its entries with the resource record in question, step 58.

In order for the second device 16 to use the additional connection it has to find out the device name and an application specific service name of the first device 10. If the second device had initiated the session it would have been able to find out the locatable device name of the first device 10 by the normal DNS_SRV query when setting up the first connection. It would then only need the service name, which could have been pre-set by the application. In case the second device 16 does not know these names it can request the first device 10 to provide a device name and the application specific service name to use or only the service name if it already knew the device name. This request would then be transmitted between the two socket layer engines 32 in the devices. The application specific service name and possible fully qualified domain name of the first device 10 is then sent from the first device 10 to the second device 16 over the first connection, through the two socket layer engines 32 communicating with each other using the connection layer engines 34 and the first connection. As the second device 16 now has this fully qualified domain name and application specific service name, it can query the name and service resolving unit 22 of the first gateway 14 regarding this address and service name using a standard SRV_DNS query. As the application in the second device 16 now needs the additional connection, the application layer engine 30 sends a request for a connection to the socket layer engine 32. When the socket layer engine 32 of the second device 16 now receives this request, step 59, it orders, using a get command, the connection layer engine 34 to send such a query intended for the name and service resolving unit 22 associated with first device 10, step 60. The name and service resolving unit 22 associated with the first device 10 here answers with the local address AX and second port number PX2 of the first device 10 in the first local addressing realm, step 62, which gets translated into the gateway address A2G1 and a corresponding gateway port number of the global addressing realm by the DNS_SRV ALG 24 in the first gateway 14, step 64, which response is forwarded towards the second local network 18, step 66. A binding is then performed in the NAPT 28 of the first gateway 14 between the first address AX and second port number PX2 of the first device 14 and the global address A2G1 of the first gateway 14 and the selected port number for allowing connection to the first device 10 from outside the first local network 12. This address of the first gateway is thus associated with the address of the first device. When the response reaches the second gateway 20, the destination address is translated from the address A2G2 into the address AY of the second device 16, because of a previously made binding in the NAPT 28 of the second gateway 20, whereupon the response is received by the second device 16, step 67. The socket layer engine 32 of the second device 16 can now bind a socket to its own address AY and an application specific port number for the additional connection, which connection can now be used by the two devices, step 68.

When the communication on the additional connection is ended, the socket layer engine 32 of the first device 10 orders the connection layer engine 34 to send a request to its associated name and service resolving unit 22 to remove the resource record 26 in order to not bind port numbers to addresses unnecessarily, step 70. For every new connection that is set up a new name and service resolving process needs to be executed. Therefore the first device should not store the address and port number of the destination device and service.

The service name also includes protocol information in order to let the other device know the protocol that is associated with the service.

Above was described how the additional connection was set up from the second device. Naturally the first device could have initiated the session instead, in which the case the second device would have provided the resource record to a corresponding DNS_SRV unit. The first session could furthermore have been initiated by the second device instead of the first device. Moreover the functionality for providing the resource record was described as being implemented in the first device, while the functionality for obtaining the information in the resource record using a query to the DNS_SRV unit was described as being provided in the second device. Normally both these sets of functionalities would be present in all computational devices. It is furthermore not necessary for the resource record to include address information of the first device. It is sufficient to include the port number. The local name and service resolving unit can here be able to find out the name by looking at the source address of the message including the resource record sent to it from the first device. The second device would of course only query the application specific service name and not the device name. It is furthermore not necessary to already have a session initiated over a first connection in order set up a connection according to the invention. A device could send a resource record, which is then used by the other device when initiating the session.

The present invention is thus directed towards abstracting the use of address and port numbers in relation to setting up connections for an application running on at least two devices. Because of this abstraction the messages sent in a session need not include addresses and port number information for setting up connections, which information can be affected negatively when provided in a payload traversing interfaces between different addressing realms. Such negative influence comprises for instance scrambling and forbidden use of well-known port numbers. The addresses and port numbers are obtained through name and service queries, preferably in the form of DNS_SRV queries, which guarantees that possible address translations are taken care of automatically in the networks if they have address translation capabilities. This furthermore makes the invention network independent and allows it to be implemented virtually for any network. Other advantages are that a special ALG is not required, instead the functionality of the existing one that is provided in relation to normal device name and service name resolving and different addressing realms is used. Multi-tier applications are also enabled. The existing infrastructure can be used, like for instance the DNS_SRV protocol, which makes the invention straightforward and cost-efficient to implement. The present invention furthermore enables multiple servers of the same type within a private network without configuration. With the initiation process described initially, multiple inbound sessions using one address in the global network is furthermore enabled.

In the above, the name and service resolving unit was placed in a gateway. The name and service resolving unit can as an alternative be a separate entity or server on a local network with which the gateway in question would communicate in order to resolve the name and service. Another possible variation is that the name and service resolving unit can be distributed in the various end devices of the first network including the first and/or second device.

The different units in a computational device can be provided in the form of hardware components. However, they are normally provided in the form of one or more processors together with suitable program memory containing appropriate program code for performing the method according to the invention. The software or program code for performing this can also be provided on a computer program product in the form of a computer readable medium, which will perform the part of the method according to the invention provided in one computational device when loaded into the computational device in question. One such medium in the form of a CD Rom disc 72 is depicted in FIG. 6, although there are many different mediums possible such as diskettes. The program code can also be downloaded remotely from a server outside the local networks.

The present invention thus provides a system of computational devices, computational devices, a method and a computer program product for abstracting address and port number usage in the communication between at least two computational devices.

There are a number of possible variations to the invention, which can be made in addition to those already mentioned. As mentioned earlier the application in the first device need not provide a service name to the socket layer engine. In this case the socket layer engine would generate one instead. This name would include a seemingly random combination of symbols that do not have any specific meaning other than clearly identifying a certain port number. After the socket layer engine has bound a socket to the port number, it then provides the name to the application. The application can then use this name within payloads of messages sent to the second device. In this way the application running on the first device can notify the application running on the second device of the service name, which is needed for contacting the created socket.

The two devices need not be provided in different local networks, although the invention is most advantageous in this set up. They can also be provided in the same local network, the same global network or one be provided in a global network and the other in a local network. The invention is furthermore not limited to two devices communicating in a session, but is also applicable to three or more such devices. The invention is furthermore not limited to IP-addressing, but other types of addressing are also possible. The networks do not need to be fixed networks, but can also for instance be wireless networks instead.

1. Method of abstracting address and port number usage for an application (30) running on at least a first (10) and a second (16) device and comprising, in the first device, the steps of:
receiving a request for binding of a socket to a service from the application in said first device, (step 50),
obtaining an application specific service name to be used for a connection between the devices, (step 51),
generating a resource record (26) comprising a binding between at least a port number (PX2) of said first device on the one hand and the application specific service name on the other hand, (step 52),
creating a socket and binding it to the port number, (step 53), and
ordering the sending of the resource record to an associated local name and service resolving unit (22), (step 54), such that the resource record can be stored in the name and service resolving unit in order to allow the application running in the second device to obtain an address and port number associated with the first device for use for a connection through sending a query to the name and service resolving unit about the application specific service name of the first device.

2. Method according to claim 1, wherein the resource record also comprises a binding between a locatable device name and an address (AX) of the first device.

3. Method according to claim 1, further comprising the step of ordering the sending of at least the application specific service name to the second device for allowing the set up of the additional connection.

4. Method according to claim 3, wherein the step of ordering the sending comprises ordering the sending also of a device name of the first device.

5. Method according to claim 1, wherein the step of obtaining a service name comprises receiving the service name from the application running in the device.

6. Method according to claim 1, wherein the step of obtaining a service name comprises generating a service name to be used.

7. Method according to claim 6, further comprising the step of returning the generated service name to the application.

8. Method according to claim 1, further comprising the step of ordering removal of the resource record from the associated name and service resolving unit once the connection is no longer needed, (step 70).

9. Method according to claim 1, wherein the service name includes protocol information.

10. Method according to claim 1, further comprising, in the second device, the steps of:
receiving a request for a connection to the application in the first device from the application in the second device, (step 59),
ordering the sending of a query regarding at least said application specific service name of the first device intended for the name and service resolving unit associated with the first device, (step 60), and
receiving address and port number information associated with the first device as a result of the query, such that the connection can be set up using the received address and port number, (step 67).

11. First computational device (10) for abstracting address and port number usage for an application (30) running on at least the first and a second (16) device, comprising:
a socket layer engine (32) arranged to:
receive a request for binding of a socket to a service from the application in said first device,
obtain an application specific service name to be used for a connection between the devices,
generate a resource record (26) comprising a binding between at least an own port number (PX2) on the one hand and the application specific service name on the other hand,
create a socket and bind it to the port number, and
order the sending of the resource record to a local name and service resolving unit (22) associated with the first device, such that the resource record can be stored in the name and service resolving unit, for allowing the application in the second device to obtain an address and port number associated with the first device for use in communication by means of a query regarding at least the application specific service name of the first device.

12. Computational device according to claim 11, wherein the resource record also comprises a binding between a locatable device name and an address (AX) of the first device.

13. Computational device according to claim 11, wherein the socket layer engine is further arranged to order the sending of at least the application specific service name to the second device for allowing the set up of the connection.

14. Computational device according to claim 13, wherein the socket layer engine is also arranged to order the sending of the device name of the first device.

15. Computational device according to claim 11, wherein the socket layer engine is further arranged to, in obtaining a service name, receive the service name from the application running in the device.

16. Computational device according to claim 11, wherein the socket layer engine is further arranged to, in obtaining a service name, generate a service name to be used.

17. Computational device according to claim 16, wherein the socket layer engine is further arranged to return the generated service name to the application.

18. Computational device according to claim 11, wherein the socket layer engine is further arranged to order the removal of the resource record from the name and service resolving unit once the additional connection is no longer needed.

19. Computational device according to claim 11, wherein the service name includes protocol information.

20. Second computational device (16) for abstracting address and port number usage for an application (30) running on at least a first (10) and the second device and comprising:
a socket layer engine (32) arranged to:
receive a request for a connection from the application in said second device,
order the sending of a query regarding at least an application specific service name associated with the first device to a name and service resolving unit (22) associated with the first device, which name and service resolving unit has a resource record (26) comprising a binding between an address (AX) and a port number (PX2) of said first device on the one hand and at least the application specific service name on the other hand, and
receive an address and port number associated with the first device as a response to the query for use in setting up a connection, such that the connection can be set up using the received address and port number.

21. System of computational devices for abstracting address and port number usage for an application (30) running on at least a first (10) and a second (16) device and comprising:
said first computational device having a socket layer engine (32) arranged to:
receive a request for binding of a socket to a service from the application in said first device,
obtain an application specific service name to be used for a connection between the devices,
generate a resource record comprising a binding between at least an own port number (PX2) of the first device on the one hand and the application specific service name on the other hand,
create a socket and bind it to the port number, and
order the sending of the resource record to a local name and service resolving unit (22) associated with the first device, such that the resource record can be stored in the name and service resolving unit,
said second computational device having a socket layer engine (32) arranged to:
receive a request for a connection from the application in said second device,
order the sending of a query regarding the application specific service name associated with the first device to the name and service resolving unit associated with the first device, and
receive an address and port number associated with the first device for use in setting up a connection as a response to the query, such that the connection can be set up using the received address and port number.

22. Computer program product (72) to be used on a first computational device (10) for abstracting address and port number usage for an application (30) running on at least the first and a second (16) device, said computer program product having:
computer program code, to make the first device execute, when said program code is loaded in the first device:
receive a request for binding of a socket to a service from the application in said first device,
obtain an application specific service name to be used for a connection between the devices,
generate a resource record (26) comprising a binding between at least a port number (PX2) of said first device on the one hand and the application specific service name on the other hand,
create the socket and bind it to the port number, and
order the sending of the resource record to a local name and service resolving unit (22) associated with the first device, such that the resource record can be stored in the name and service resolving unit for allowing the application in the second device to obtain an address and port number associated with the first device for use for setting up a connection by means of a query regarding the device name and application specific service name of the first device.

23. Computer program product (72) to be used on a second computational device (16) for abstracting address and port number usage for an application (30) running on at least a first (10) and the second device, said computer program product having:
computer program code, to make the second device execute, when said program code is loaded in the second device:
receive a request for a connection from an application (30) in said second device,
order the sending of a query regarding at least an application specific service name associated with the first device to a name and service resolving unit (22) associated with the first device, which name and service resolving unit has a resource record (26) comprising a binding between an address (AX) and a port number (PX2) of said first device on the one hand and the application specific service name on the other hand, and
receive an address and port number associated with the first device for use in setting up a connection as a response to the query, such that the connection can be set up using the received address and port number as well as an own address (AY) and port number.
